(19) United States
(12) Patent Application Publication
(10) Pub. No.: US 2003/0139562 A1
(43) Pub. Date: Jul. 24, 2003

(54) Reacted PUR binders for coil-coating lacquers

(76) Inventors: Eberhard Koenig, Leverkusen (DE); Beate Baumbach, Leverkusen (DE); Christian Fussel, Tonisvorst (DE)

Correspondence Address: BAYER POLYMERS LLC, 100 BAYER ROAD, PITTSBURGH, PA, 15205, US

(21) Appl. No.: 10/313,181

(22) Filed: Dec. 6, 2002

(30) Foreign Application Priority Data
Dec. 10, 2001 (DE) 10160570.6

(51) Int. Cl. C08G 18/00

(52) U.S. Cl. 528/44

(57) ABSTRACT

The invention relates to reacted lacquer binders, their production and use in polyurethane single-component stoving enamels, in particular for the coil coating process.

The invention relates to reacted lacquer binders, their production and their use in polyurethane single-component stoving enamels, in particular for the coil-coating process.

According to the prior art, so-called single-component and storage stable binders for PUR stoving enamels are produced by mixing blocked polyisocyanates with OH-containing polycondensates or polymers (polyesters or polyacrylates) (e.g. EP-A 125438, EP-A 50284). Partially-blocked polyisocyanates, which, however, still have free NCO groups, and their use for the production of powder coatings, are known from EP-A 50 284.

As is known, the blocking agent performs two functions in these single-component lacquers: firstly, it prevents a premature reaction between the NCO groups it is blocking and the OH component and secondly, it regulates the hardening of the lacquers in a certain temperature range through its specific de-blocking characteristic. However, in addition to these desirable characteristics, the individual blocking agents also have undesirable characteristics, such as e.g. a tendency to crystallisation or discolouration, insufficient economy and critical physiological effects. These can be explained through the examples of butanone oxime and 3,5-dimethylpyrazole. Both blocking agents are compatible with the known lacquer polyisocyanates and de-block at about 30″(min.)/130-140° C. On the other hand, butanone oxime has a tendency to produce discolouration in the stoved enamel and is suspected to be carcinogenic. Dimethylpyrazole is produced from acetyl acetone and hydrazine hydrate by a laborious method and gives coatings an unpleasant odour.

The object of the invention was therefore to restrict the content of blocking agents in PUR stoving enamels to a minimum.

This object was achieved by the PUR binders according to the invention for single-component PUR stoving enamels.

The invention provides single-component PUR binders, containing

A) 100 equivalent % of an aliphatic and/or cycloaliphatic lacquer polyisocyanate

B) 60-90 equivalent % of a blocking agent for isocyanate groups

C1) 80-95 equivalent % of a polymeric OH component and

C2) 5-20 equivalent % of an OH-functional hydrazide compound

and

optionally other additives,

characterised in that the mixture of A+B+C1+C2 has no free, but only blocked NCO groups and wherein the equivalent ratio of A:[C1+C2] is equal to 1:1 to 1:1.1.

In the binder mixtures according to the invention, the NCO component A) is present not in a fully, but only a partially blocked form and the unblocked NCO groups of component A) are reacted with the OH components (C1+C2).

In addition to the four components referred to, which are essential to the invention, the binders according to the invention may also contain further additives such as fillers, application auxiliaries, stabilising additives such as e.g. HALS amines, solvents and/or thinners, as well as the conventional additives, pigments etc.

The lacquer polyisocyanates known per se, based on (cyclo)aliphatic diisocyanates with an NCO content of 12 to 25 wt. %, and containing biuret-, isocyanurate-, allophanate-, iminooxadiazine dione (asymmetric trimeric)-, urethane- and/or uretdione groups, may be considered for component A). Examples of aliphatic or cycloaliphatic diisocyanates are 1,6-diisocyanatohexane (HDI), 1-isocyanato-3,3,5-trimethyl-5-isocyanatomethylcyclohexane (isophorone diisocyanate, IPDI), bis-(4-isocyanatocyclohexyl)-methane (H₁₂MDI or Desmodur W®/Bayer AG), 2,6- or, 2,5-bisisocyanatonorbornane or 1,4-bisisocyanatomethylcyclohexane and 1,3- or 1,4-tetramethylxylene dilsocyanate. Polyisocyanates based on 1,6-diisocyanatohexane, IPDI and Desmodur® W, and containing isocyanurate groups, are primarily preferred. Oxims, such as e.g. butanone oxime, secondary aliphatic amines, such as e.g. diiso-propylamine, CH-acid compounds, such as e.g. malonic or acetoacetic ester, NH-acid heterocyclics such as e.g. 1,2,4-triazole, imidazole or 3,5-dimethylpyrazole, lactams such as e.g. F-caprolactam, alcohols such as e.g. methanol, ethanol or n-propanol or mixtures of these blocking agents are preferred as blocking agent B). ε-caprolactam, diisopropylamine, 1,2,4-triazole or mixtures thereof are preferred in particular.

Polyesters, polyethers, polycarbonates or polyacrylates in the OH number range of 50-500 are used as polymeric OH component C1). Branched polyesters with OH numbers of 60 to 140 are preferred. 1,2-propanediole, neopentylglycol, hexanediol-1,6 or trimethylolpropane on the one hand, and maleic acid anhydride, adipic acid, isophthalic acid or phthalic acid anhydride may be considered as components for these hydroxyl polyesters.

The addition product of hydrazine hydrate to 2 mol propylene carbonate of the formula (I):

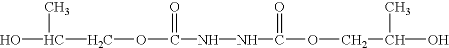

(molecular weight 236)

known e.g. from EP-A 0829 500 is preferred as a stabilising component C2) to control thermo-discolouration.

The invention also provides a process for the production of the PUR binders according to the invention, characterised in that the lacquer polyisocyanate A) is provided and reacted with the blocking agent B) whilst stirring at 70-100° C. until the calculated NCO content is achieved, is then diluted with a solvent inert towards NCO groups e.g. solvent naphtha 100 or 1-methoxy-2-propylacetate and the total quantity of the OH components (C1+C2) is quickly added at ca. 60° C. and stirred at ca. 60° C. until NCO groups can no longer be detected by IR spectroscopy.

The binder according to the invention is thus obtained, ready for use, in dissolved form.

The OH components (C1+C2) are added within a period of up to 45 min, preferably 1 to 30 min, quickly enough to allow a temperature of ca. 60° C. to be maintained.

The advantages of the PUR binders according to the invention are summarised as follows:

they have a lower content of blocking agents than comparable blocked binders and

are significantly more reactive.

The invention further provides the use of the PUR binders according to the invention for single-component PUR stoving enamels. These can be used to coat substrates of metal, ceramics, glass, plastics and wood.

The single-component PUR binders according to the invention are preferably used for coating in the coil-coating process.

### EXAMPLES

Solvesso®, solvent naphtha: aromatic lacquer solvents, Exxon Chemicals, Houston, USA

### Example 1

(According to the Invention)

Single-Component PUR Binder

To 100 equivalent % of the polyisocyanate component A), 72.7 equivalent % of the blocking agent B) (in this case, dilsopropylamine) are used, the difference from 100% equivalent % being made up by the OH components (C1+C2).

Batch:

| 192.5 | g | (0.55 | Val) | of an isocyanurate-containing lacquer | |
|---|---|---|---|---|---|
| | | | | polyisocyanate based on 1-isocyanato-3,3,5- | |
| | | | | trimethyl-5-isocyanato-methyl-methyl- | |
| | | | | cyclohexane (IPDI), in a 70% solution with | |
| | | | | solvent naphtha 100, with an NCO content of | |
| | | | | 12.0% and a functionality of ca. 3.2 | |
| 107.8 | g | (0.55 | Val) | of an isocyanate-containing lacquer | |
| | | | | polyisocyanate based on 1,6-diisocyanato- | |
| | | | | hexane (HDI) with an NCO content of | |
| | | | | 21.4%, a viscosity at 23° C. of | |
| | | | | ca. 3000 mPas and a functionality of ca. 3.5 | |
| 80.8 | g | 0.8 | (Val) | Diisopropylamine (DIPA) | |
| 500.0 | g | (1.0 | Val) | Desmophen ® 670 (lightly branched | |
| | | | | hydroxylpolyester, as an 80% solution in | |
| | | | | butylacetate, OH content as supplied 3.4%, | |
| | | | | Bayer AG) | |
| 11.8 | g | (0.1 | Val) | Addition product of 2 mol propylene car- | |
| | | | | bonate and 1 mol hydrazine hydrate, | |
| | | | | M = 236 g/mol | |
| 166.1 | g | | | 1-methoxy-2-propylacetate | |
| 166.1 | g | | | Solvent naphtha 100 | |
| 1225.1 | g | | | Single component PUR binder | |
| | | | | Solid content: | Calc. 60% |
| | | | | Viscosity at 23° C.: | ca. 1260 mPas |

Method

Both of the polyisocyanates and the solvents are provided and set at a temperature of 40° C. DIPA is added in portions. After the DIPA has been added, stirring takes place for a further 1 hour at 60° C. An NCO content of 1.75% is found, 1.76% is calculated. The hydrazide adduct and the polyester are then added rapidly and reacted for ca. another 5 hours at 60° C., until NCO groups can no longer be detected by IR spectros-copy. A pale yellow solution of a binder with the above-mentioned characteristics is obtained.

### Example 2

(According to the Invention)

Single-component PUR binder containing a mixed blocker of 1,2,4-triazole and diisopropylamine. To 100 equivalent % of the polyisocyanate component A) there are 72.7 equivalent % of blocking agent B) and the difference from 100 equivalent % is made up by the OH components (C1+C2).

Batch:

| 385.0 | g | (1.1 | Val) | of an isocyanurate-containing polyisocyanate | |
|---|---|---|---|---|---|
| | | | | based on IPDI (cf. example 2) | |
| 27.6 | g | (0.4 | Val) | 1,2,4-triazole | |
| 40.4 | g | (0.4 | Val) | Diisopropylamine (DIPA) | |
| 807.5 | g | (0.95 | Val) | Alkynol ® VP LS 2013 (lightly branched | |
| | | | | hydroxyl polyester in 75% solution with sol- | |
| | | | | vent naphtha 100, OH content as supplied | |
| | | | | 2%, 1 OH equivalent = 850 g, Bayer AG) | |
| 17.7 | g | (0.15 | Val) | Addition product of 2 mol propylene carbon- | |
| | | | | ate and 1 mol hydrazine hydrate, M = 236 g/ | |
| | | | | mol | |
| 5.0 | g | | | Tinuvin ® 770 DF (HALS-amine, Ciba | |
| | | | | Spezialchemikalien) | |
| 163.2 | g | | | 1-methoxypropylacetate | |
| 163.2 | g | | | Solvent naphtha 100 | |
| 1609.6 | g | | | Single-component PUR binder | |
| | | | | Solids content: | calc. 60% |
| | | | | Viscosity at 23° C. | ca. 1100 mPas |

Method

The polyisocyanate, 1-methoxypropylacetate and 1,2,4-triazole are provided and heated to 100° C. whilst stirring. After ca. I hour reaction time at 100° C., the NCO content has fallen to the calculated NCO content of 5.1%. Solvent naphtha 100 is added, the mixture is cooled to 60° C. and DIPA is added in portions. After stirring for 1 hour at 60° C., the calculated NCO content of 1.6% is determined. The polyester and the hydrazide adduct are added rapidly and reacted at 60° C. for ca. 5 hours until NCO groups can no longer be detected by IR spectroscopy. A virtually colourless binder solution with the above characteristics is obtained.

### Example 3

(Reference)

The binder according to example 1 is divided into a fully-blocked polyisocyanate and the OH components.

Batch:

| | | | | |
|---|---|---|---|---|
| 192.5 | g | (0.55 | Val) | of the IPDI trimer according to example 1 |
| 107.8 | g | (0.55 | Val) | of the HDI trimer according to example 1 |
| 111.1 | g | (1.1 | Val) | diisopropylamine |
| 166.1 | g | | | 1-methoxypropylacetate |
| 166.1 | g | | | Solvent naphtha 100 |
| 743.6 | g | (1.1 | Val) | blocked polyisocyanate crosslinker |
| 500.0 | g | (1.0 | Val) | Desmophen ® 670 (cf. example 1) |
| 11.8 | g | (0.1 | Val) | addition compound of 2 mol propylene car- |
| | | | | bonate and 1 mol hydrazine hydrate (after |
| | | | | distilling off the hydrate water, a colour- |
| | | | | less oil remains, with M = 236 g/mol |
| 1255.4 | | | | single-component PUR binder |

In contrast to the binder according to example 1, this binder is not partially reacted. Although it contains the same components, it consists of a mixture of fully-blocked polyisocyanate and OH components.

### Example 4

(Reference)

The binder according to example 2 is divided up into the corresponding fully-blocked polyisocyanate and the OH component. Otherwise, all the components are identical.

Batch:

| | | | | |
|---|---|---|---|---|
| 385.0 | g | (1.1 | Val) | IPDI trimer according to example 2 |
| 38.0 | g | (0.55 | Val) | 1,2,4-triazole |
| 55.5 | g | (0.55 | Val) | diisopropylamine |
| 163.2 | g | | | 1-methoxy-2-propylacetate |
| 163.2 | g | | | solvent naphtha 100 |
| 804.9 | g | (1.1 | Val) | blocked polyisocyanate |
| 5.0 | g | | | Tinuvin ® 770 DF |
| 807.5 | g | (0.95 | Val) | Alkynol ® VP LS 2013 (cf. example 2) |
| 17.7 | g | (0.15 | Val) | addition compound of 2 mol propylene car- |
| | | | | bonate and 1 mol hydrazine hydrate with |
| | | | | M = 236, hydrate water was distilled off. |
| 1635.1 | g | | | single-component PUR binder |

This binder is produced by the method described in example 2, in which the fully-blocked polyisocyanate component is produced first, and the OH components and HALS amine are then mixed in.

### Example 4

(Lacquer Results)

The binders from examples 1-4 are processed in the Scandex mixer with the following additives to form lacquer batches (data in wt. %).

| | |
|---|---|
| Binder from examples 1 to 4 | 48.7 |
| Kronos ® 2160, titanium dioxide from Kronos | 29.2 |
| Acronal ® 4F, levelling agent and de-foamer from BASF | 1.5 |
| Celluloseacetobutyrate ® CAB-531-1, 10% in solvent naphtha | 7.3 |
| 200 S/butyldiglycol (2:1), levelling agent from Eastman, USA | |
| Dibutyltindilaurate, 10% in Solvesso ® 200 S, catalyst from Air | 0.9 |
| Products, USA | |
| Solvesso ® 200 S, solvent naphtha 200 S, Exxon Chemicals | 12.4 |
| | 100.0 |

Four lacquer batches result with a processing viscosity of ca. 70 sec. DIN 4/23° C. These lacquers are applied to chromatised aluminium sheets (1 mm) in a dry layer thickness of ca. 20 μm and stoved in an Aalborg oven on the turntable at 350° C. The following lacquer properties were measured.

| | Results | | | |
|---|---|---|---|---|
| | Lacquer 1 | | Lacquer 2 | |
| | according to | Lacquer 3, | according to | Lacquer 4, |
| | example 1 of | reference, | example 2 of | reference, |
| Test | the invention | example 3 | the invention | example 4 |
| Berger whiteness, | 94.9 | 94.5 | 95.1 | 94.7 |
| Peak metal tempera- | | | | |
| ture—PMT | | | | |
| 232° C. | | | | |
| Whiteness, PMT | 94.3 | 93.5 | 94.5 | 93.8 |
| 254° C. | | | | |
| Δ whiteness | 0.6 | 1.0 | 0.6 | 0.9 |
| Reactivity test | | | | |
| methylethylketone | | | | |
| (MEK)-wipe test, | | | | |
| double stroke | | | | |
| ECCA-T11¹⁾ and | | | | |
| DIN EN 12720 | | | | |
| at PMT 199° C. | 100 | 20 | 100 | 2 |
| at PMT 204° C. | 100 | 100 | 100 | 100 |

1) ECCA. = European Coil Coating Association

In addition to the above tests, other lacquer industry tests, such as e.g. microhardness determination, impact test (ECCA-T5), adhesion at 6 mm Erichsen indentation in the grid section (ECCA-T 6), T-bend test (ECCA-T 7), post-tensile strength 30 min. 100° C. were carried out. Here, the results for the binders according to the invention and the reference binders were equally good.

These results show that the binders according to the invention have slightly better whiteness values than their respective reference lacquers. However, the essential point is that the PUR binders according to the invention (lacquers 1 and 2) are already fully crosslinked at a PMT of 100° C., whilst the reference lacquers achieve this degree of crosslinking, as can be seen from the 159° C. double strokes in the MEK wipe test, only at 204 respectively, which gives the binder according to the invention a great advantage in terms of application and processing.

1. Single-component PUR binders, containing
A) 100 equivalent % of an aliphatic and/or cycloaliphatic lacquer poly-isocyanate
B) 60-90 equivalent % of a blocking agent for isocyanate groups
C1) 80-95 equivalent % of a polymeric OH component and
C2) 5-20 equivalent % of an OH-functional hydrazide compound
and
optionally other additives,
characterised in that the mixture of A+B+C1+C2 has no free, but only blocked NCO groups and the equivalent ratio of A:[C1+C2] is equal to 1:1 to 1:1.1.

2. Single-component binders according to claim 1, characterised in that the OH-functional hydrazide compound of the formula (I) 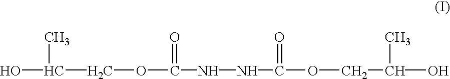
is used as component C2):

3. Binders according to claim 1, characterised in that the blocking agents B) are 6-caprolactam, 1,2,4-triazole or dilsopropylamine or mixtures of these blocking agents.

4. Single-component PUR binders according to claim 1, characterised in that they contain stabilising additives.

5. Process for the production of the PUR binders according to claim 1, characterised in that lacquer polyisocyanate A) is provided and reacted with blocking agent B) whilst stirring at 70-100° C. until the calculated NCO content is achieved, and then diluted with a solvent inert towards NCO groups and the total quantity of the OH components (C1+C2) is then added rapidly at 60° C. and stirred at 60° C. until NCO groups can no longer be detected by IR spectroscopy.

6. Use of the PUR binders according to claim 1 for single-component PUR stoving enamels.

7. Use of the binders according to claim 1 for coil-coatings.
